(19) United States
(12) Patent Application Publication
(10) Pub. No.: US 2026/0049445 A1
(43) Pub. Date: Feb. 19, 2026

(54) FULL-AUTOMATIC FABRIC RECTANGULAR CUTTING EQUIPMENT

(71) Applicant: Beijing Hengmeite Technology Co., Ltd., Beijing (CN)

(72) Inventor: Xiaojun Li, Beijing (CN)

(21) Appl. No.: 18/807,807

(22) Filed: Aug. 16, 2024

(51) Int. Cl. D06H 7/02; B26D 7/02; D06H 7/04

(52) U.S. Cl. CPC D06H 7/02; B26D 7/025; D06H 7/04

(57) ABSTRACT

A full-automatic fabric rectangular cutting equipment, comprising a working frame and a material transferring belt set on an upper part of working frame, a conveyor gantry support frame, a horizontal cutting moving mechanism and a vertical cutting moving mechanism on upper part of working frame along running direction of material transferring belt; a plurality of pressure sheets are set at intervals at a lower part of the conveyor gantry support frame, one end of pressure sheets corresponding to running direction of material transferring belt is connected with horizontal cutting moving mechanism via pressure exerting components. The invention ensures equal pressure at each point by contacting pressure sheets with fabric to be transferred, and realizes uniform force at all pressure points, resulting in smaller transfer error; by setting horizontal cutting tool mechanism and vertical cutting tool mechanism respectively, the device can cut the material horizontally and vertically.

### 1. TECHNICAL FIELD

The invention belongs to the technical field of cutting equipment, specifically relates to a full-automatic fabric rectangular cutting equipment.

### 2. BACKGROUND ART

Felt is a commonly used industrial tools, mostly made of wool, but some also made of ox hair or fibers through processing and bonding, featuring high resilience and can be used as materials in anti-vibration, sealing, gasket and elastic steel wire needle felt cloth base material, and applied to a variety of industrial machinery-anti-vibration, oil lubrication, friction resistance, and other industries; in the production process felt and other materials of the same type, they usually need to be cut to a certain width and then wound into rolls to facilitate subsequent storage and sale. Cutting machine is a kind of auxiliary device used in the production and processing of felt and other materials to cut them and make them meet the processing requirements, which is widely used in the technical field of felt production equipment; the existing cutting machine needs manual movement of the cutter when cutting felt, the degree of automation is low, and the workload of the workers is large, the efficiency is low, and most of the existing cutting machines can only cut in one direction, not in multiple directions, which is not convenient for the cutting of ultra-wide fabrics.

### 3. SUMMARY OF THE INVENTION

in order to solve said technical problem, the invention provides the following technical solution: a full-automatic fabric rectangular cutting equipment, comprising a working frame and a material transferring belt set on an upper part of the working frame, a conveyor gantry support frame, a horizontal cutting moving mechanism and a vertical cutting moving mechanism set on the upper part of the working frame along running direction of the material transferring belt; a plurality of pressure sheets are set at intervals at a lower part of the conveyor gantry support frame, and one end of pressure sheets corresponding to running direction of the material transferring belt is connected with the horizontal cutting moving mechanism via pressure exerting components; on horizontal cutting moving mechanism is provided with a horizontal cutting tool mechanism, and on the vertical cutting moving mechanism is provided with vertical cutting tool mechanisms; in front of the working frame is provided with a plurality of cabinet doors with locks, in the cabinet door with lock is provided with a distribution box, bottom corners of the working frame is are provided with support feet.

By adopting the above technical solution, the invention has following advantages: (1) pressure sheets contact with the fabric to be transferred by arranging a plurality of pressure sheets and pressure exerting components, and pressure exerted by each pressure sheet is controlled by the pressure exerting component, the invention can realize that pressure exerted by each pressure sheet is roughly the same, and ensures equal pressure at each point of the working table and realizes uniform force at all pressure points, resulting in smaller transfer error; (2) by setting the horizontal cutting tool mechanism and the vertical cutting tool mechanisms respectively, the device can cut the material horizontally and vertically, and increase the direction of cutting; (3) through the setting of fine-tuning components, the cutting tool can be moved up and down, which is convenient for the movement and cutting of materials; (4) the cutting machine vertical cutting mechanisms are provided to adjust the spacing between the vertical cutting tool mechanisms and thus adjusting cutting width; the vertical cutting tool can be driven up and down to ensure smooth transmission through setting of the telescopic adjusting mechanism; (5) on the vertical cutting tool mechanism is provided with a self reset mechanism, and on the horizontal cutting tool is provided with a buffer component to avoid deterioration of the balance of the blade caused by vibration; (6) a fabric shoveling mechanism is set up to shovel up the cut fabric from the material transferring belt to a lower part of the edge sealing mechanism, so that the fabric can be sealed after being cut; and the shoveled fabric and the material transferring belt are separated, so as to avoid damaging the material transferring belt when sealing edges, which is convenient and practical; (7) it can solve the falling down problem when the size of platform and gantry is large; (8) this device is adapted to a variety of materials, such as coiled material and sun-proof fabrics.

### 4. BRIEF DESCRIPTION OF ACCOMPANY DRAWINGS

In order to illustrate the preferred embodiment of the invention or the technical scheme more clearly, the technical scheme of the preferred embodiment or the figures required by the prior art is further described briefly. Obviously, only partial embodiments of the invention are shown and the actual structure is not limited thereto. It is to be understood by those skilled in the art that other drawings can be obtained based on the drawings of the invention with non-creative labor.

FIG. 1 is the structural diagram of a full-automatic fabric rectangular cutting equipment provided by the invention;

FIG. 2 is the top view of a full-automatic fabric rectangular cutting equipment provided by the invention;

FIG. 3 is the structural diagram of the horizontal cutting moving mechanism in a full-automatic fabric rectangular cutting equipment provided by the invention;

FIG. 4 is the mounting structural diagram of the horizontal cutting tool fixing support in a full-automatic fabric rectangular cutting equipment provided by the invention;

FIG. 5 is the structural diagram of the horizontal cutting tool fixing support in a full-automatic fabric rectangular cutting equipment provided by the invention;

FIG. 6 is the structural diagram of the fine-tuning component in a full-automatic fabric rectangular cutting equipment provided by the invention;

FIG. 7 is the breakdown structural diagram of the horizontal cutting tool fixing support in a full-automatic fabric rectangular cutting equipment provided by the invention;

FIG. 8 is the structural diagram of the vertical cutting moving mechanism in a full-automatic fabric rectangular cutting equipment provided by the invention;

FIG. 9 is the structural diagram of the vertical cutting tool fixing support in a full-automatic fabric rectangular cutting equipment provided by the invention;

FIG. 10 is the structural diagram of the vertical cutting tool mechanism in a full-automatic fabric rectangular cutting equipment provided by the invention;

FIG. 11 is the interior structural diagram of the vertical cutting tool mechanism in a full-automatic fabric rectangular cutting equipment provided by the invention;

FIG. 12 is the bottom structural diagram of the vertical cutting tool mechanism in a full-automatic fabric rectangular cutting equipment provided by the invention.

### 5. SPECIFIC EMBODIMENT OF THE INVENTION

In order to make the objects, technical solutions and advantages of the embodiments of the present invention clearer, the technical solutions in the embodiments of the invention will be clearly and completely described below with reference to the drawings in the embodiments of the invention, and it is obvious that the described embodiments are some, but not all, embodiments of the invention. The components of embodiments of the invention generally described and illustrated in the figures herein may be arranged and designed in a wide variety of different configurations.

### Embodiment

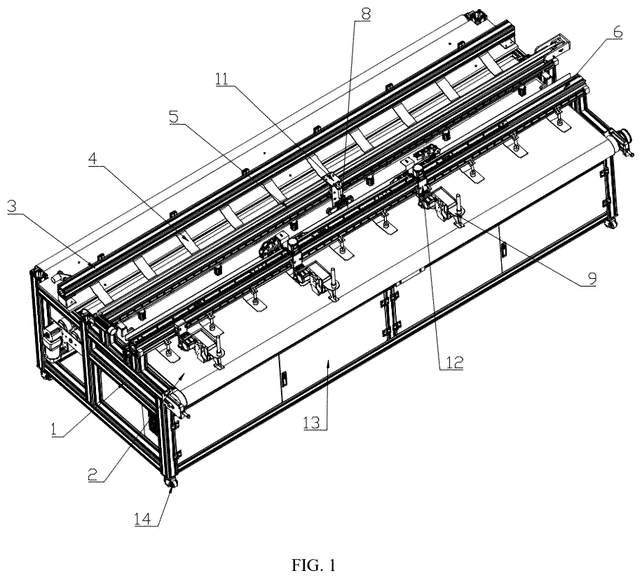

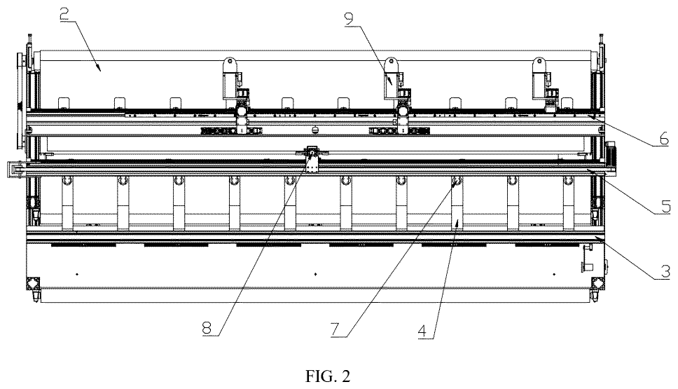

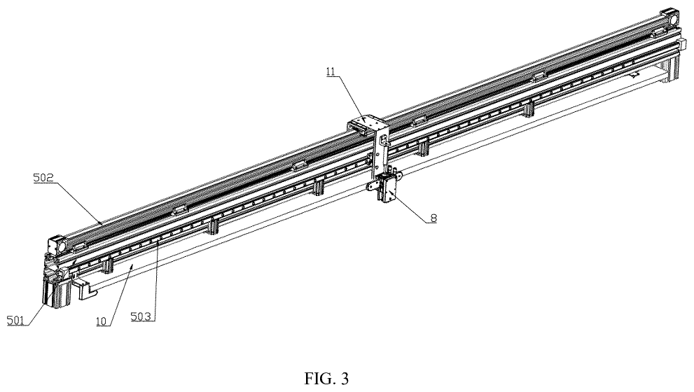

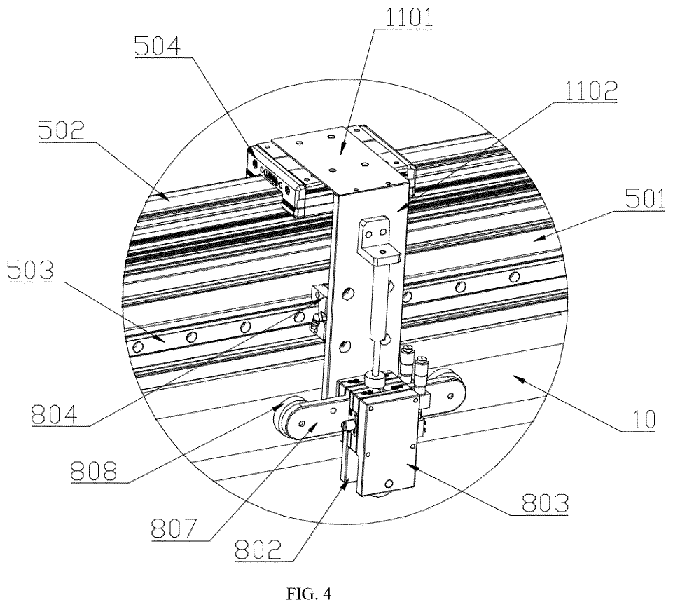

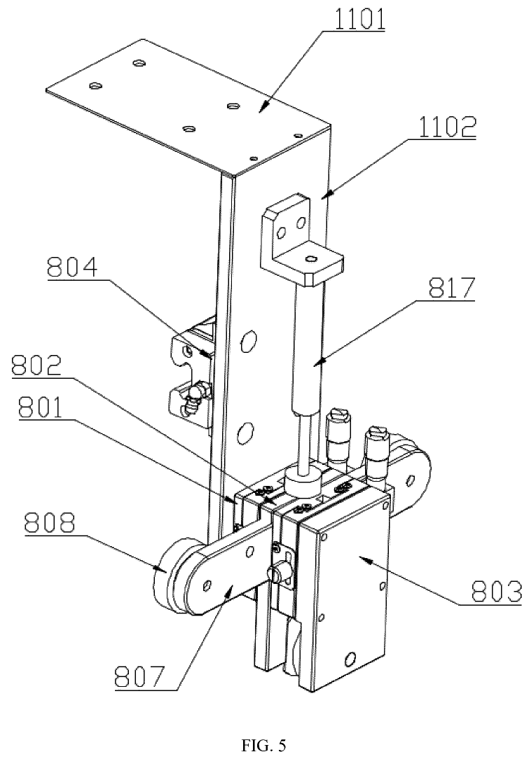

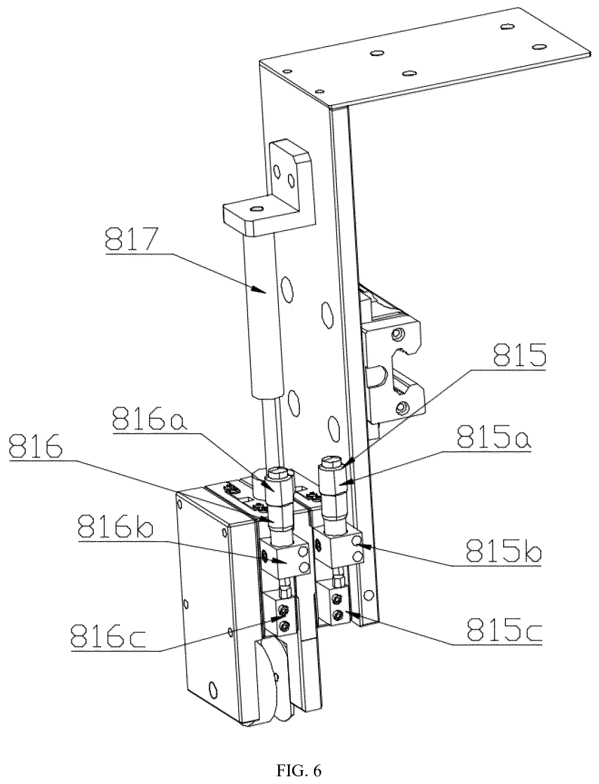

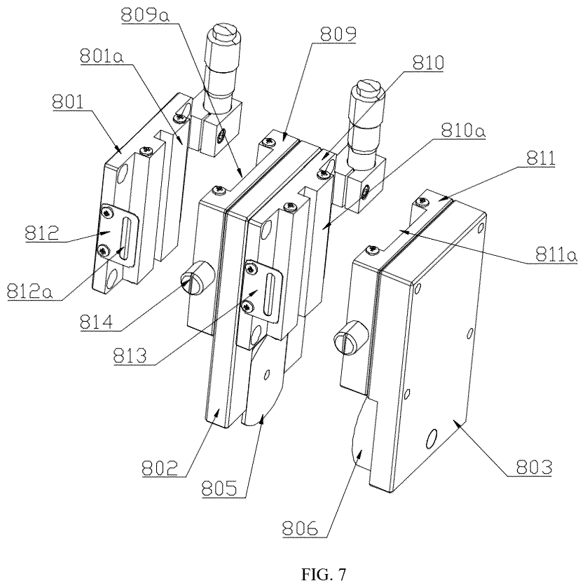

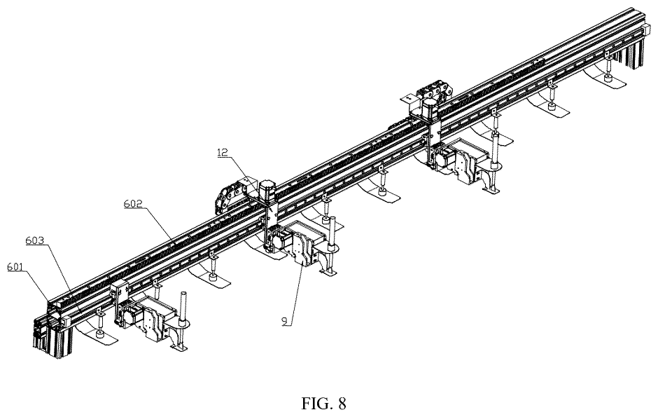

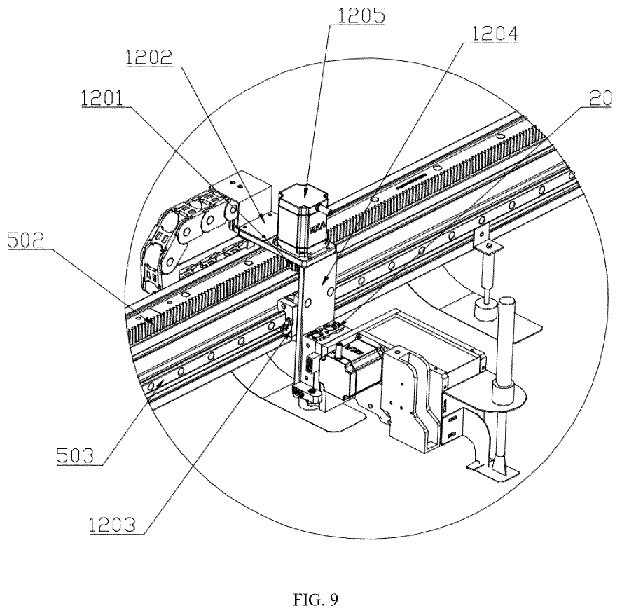

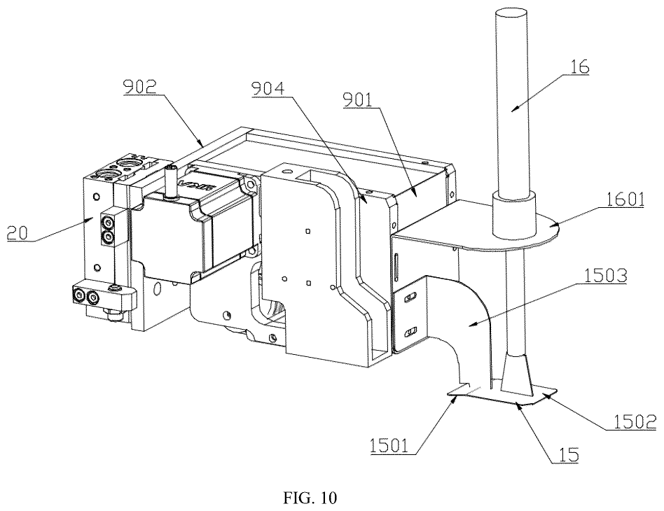

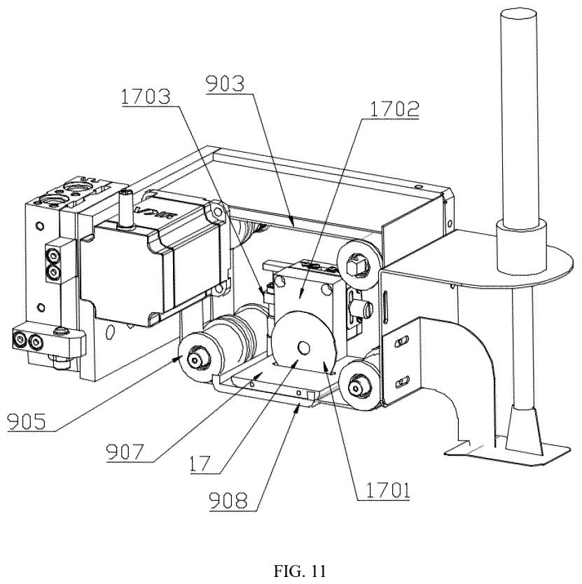

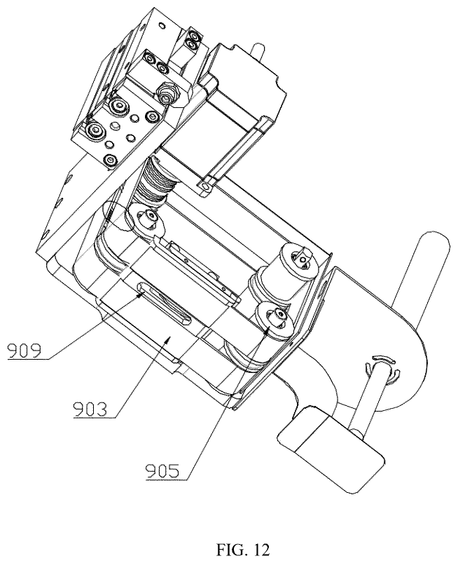

With reference to FIG. 1 to FIG. 15, the embodiment discloses a full-automatic fabric rectangular cutting equipment, comprising a working frame 1 and a material transferring belt 2 set on an upper part of the working frame 1, a conveyor gantry support frame 3, a horizontal cutting moving mechanism 5 and a vertical cutting moving mechanism 6 set on the upper part of the working frame 1 along running direction of the material transferring belt 2; a plurality of pressure sheets 4 are set at intervals at a lower part of the conveyor gantry support frame 3, and one end of pressure sheets 4 corresponding to running direction of the material transferring belt 2 is connected with the horizontal cutting moving mechanism 5 via pressure exerting components 7;

on horizontal cutting moving mechanism 5 is provided with a horizontal cutting tool mechanism 8, and on the vertical cutting moving mechanism 6 is provided with vertical cutting tool mechanisms 9; in front of the working frame 1 is provided with a plurality of cabinet doors with locks 13, in the cabinet door with lock 13 is provided with a distribution box, bottom corners of the working frame 1 is are provided with support feet 14.

Each pressure exerting component 7 includes a pressure-exerting head placed on an upper part of the pressure sheet 4 in a contacting manner, a pressure-exerting apparatus is provided on an upper part of the pressure-exerting head, and an upper part of the pressure-exerting apparatus is connected to a bottom of the horizontal cutting moving mechanism 5 via a connecting plate; in the specific embodiment, the pressure-exerting apparatus is a pneumatic cylinder or a pressure spring.

The pressure sheet 4 is a steel sheet with elasticity, and one side of the pressure sheet 4 facing the material transferring belt 2 is covered with a lubricating material layer, and the lubricating material layer may be selected from polytetrafluoroethylene; the pressure sheet 4 includes a mounting portion connected to a bottom of the conveyor gantry support frame 3, a flat pressing portion corresponding to an upper surface of the material transferring belt 2, and an arc-shaped connecting portion connected with the flat pressing portion and the mounting portion.

In specific implementation, the pressure sheet uses steel sheet with good elasticity, while its one side in contact with the fabric is covered with a lubricating material layer, such as polytetrafluoroethylene (PTFE) material, which is able to utilize the sliding between the lubricating material layer and the fabric to reduce the friction between the two, and at the same time, an other end of the pressure sheet adopts a pneumatic cylinder or a spring or a balancing weight for applying pressure to solve the problem of fabric transmission with cooperation of pressure and friction force; at the same time, the embodiment can be provided with a plurality of pressure sheets and pressure-exerting components corresponding to the pressure sheets on the working frame, so that the pressure of each pressure sheet is almost equal, which ensures that the pressure at each point of the working frame is equal, and therefore it can realize that all the pressure points are subjected to uniform pressure, which makes the transmission error smaller.

The horizontal cutting moving mechanism 5 includes a horizontal cutting gantry 501 provided between the conveyor gantry support frame 3, on a top of the horizontal cutting gantry 501 is provided with a top linear moving frame 502, and on a bottom thereof is provided with a cloth-pressing plate 10; a horizontal cutting lateral slideway 503 is provided at one side of the horizontal cutting gantry 501, and the horizontal cutting tool mechanism 8 is slidably connected to the top linear moving frame 502 and the horizontal cutting lateral slideway 503 via the horizontal cutting tool fixing support 11; the vertical cutting moving mechanism 6 includes a vertical cutting gantry 601, and a top of the vertical cutting gantry 601 is provided with a rack moving frame 602; one side of the vertical cutting gantry 601 is provided with a vertical cutting lateral slideway 603, and the vertical cutting tool mechanism 9 is connected to the rack moving support 602 and vertical cutting lateral slideway 603 by means of a vertical cutting tool fixing support 12.

The horizontal cutting tool fixing support 11 includes a transverse plate 1101 set on a top of a electric sliding block 504 in the linear moving support 502, and a vertical plate 1102 connected to the transverse plate 1101 towards the direction of the fabric; a bottom of the vertical plate 1102 is provided with a tool mounting plate 801, a tool moving plate 802, and a pressure wheel moving plate 803; one side of the horizontal cutting gantry 501 near the vertical plate 1102 is also provided with a horizontal cutting lateral slideway 503, in the vertical plate 1102 is provided with a guiding sliding block 804 in sliding connection with the horizontal cutting lateral slideway 503; a bottom of the tool moving plate 802 is provided with a cutting knife 805, and the bottom of the tool moving plate 802 is provided with a tool mounting slot, and the cutting knife 805 is set inside the tool mounting slot; a bottom of the pressure wheel moving plate 803 is rotatably connected to a pressure wheel 806; on both sides of the tool moving plate 802 are outwardly provided with a cam plate 807, and the cam plate 807 is connected to cams 808 traveling on an upper part of the cloth-pressing plate 10;

The tool mounting plate 801 is fixed to the bottom of the vertical plate 1102, specifically, one side of the tool mounting plate 801 near the tool moving plate 802 is vertically provided with a first sliding bar 801a, and two sides of the tool moving plate 802 are respectively provided with a first sliding block 809 corresponding to the tool mounting plate 801 and a second sliding block 810 corresponding to the pressure wheel moving plate 803; on the first sliding block 809 is provided with a first sliding chute 809a snapped fitted with the first sliding bar 801a, one side of the second sliding block 810 near the pressure wheel moving plate 803 is vertically provided with a second sliding bar 810a; one side of the pressure wheel moving plate 803 near the second sliding block 810 is provided with a third sliding block 811, and on the third sliding block 811 is provided with a second sliding chute 811a corresponding to the second sliding bar 810a; at the same time, an outer side of the tool mounting plate 801 is provided with a first limiting stopper 812 connected to the first sliding block 809, an outer side of the second sliding block 810 is provided with a second limiting stopper 813 connected to the third sliding block 811, wherein the first limiting stopper 812 and second limiting stopper 813 are of the same structure, one end of the first limiting stopper 812 is secured to an outer side of the tool mounting plate 801, and an other end is vertically provided with a long hole 812a; a limit column 814 that is penetrated out of the long hole 812a is provided on the second sliding block 810.

In addition, the tool moving plate 802 is slid up and down on the tool mounting plate 801 via a first fine-tuning component 815, and the pressure wheel moving plate 803 is slid up and down on the tool moving plate 802 via a second fine-tuning component 816; the first fine-tuning component 815 comprises a first cylinder 815a, a first fixing block 815b and a first moving block 815c connected to top and bottom ends of the first cylinder 815a; the first fixing block 815b is fixed to an outer side of the tool mounting plate 801, and the first moving block 815c is fixed to an outer side of the first sliding block 809; the second fine-tuning component 816 includes a second cylinder 816a, a second fixing block 816b, and a second moving block 816c connected to upper and lower ends of the second cylinder 816a, the second fixing block 816b is fixed to an outer side of the second sliding block 810, and the second moving block 816c is fixed to an outer side of the third sliding block 811 ; at the same time, a top of the tool moving plate 802 is provided with a buffer component 817 connected to the vertical plate 1102, and the buffer component is a nitrogen gas spring.

The vertical cutting tool fixing support 12 includes a transmission gear 1201 that engages with a rack moving frame 602, a transverse connecting plate 1202 that is set on the transmission gear 1201, a lateral moving block 1203 that cooperates with the vertical cutting lateral slideway 603, and a vertical connecting plate 1204 that is connected with the transverse connecting plate 1202 and the lateral moving block 1203; a bottom of the vertical connecting plate 1204 is connected to the vertical cutting tool mechanism 9 via the telescopic adjusting mechanism 20, and on the transverse connecting plate 1202 is provided with a first drive motor 1205 that drives the transmission gear 1201 to rotate.

One end of the vertical cutting tool mechanism 9 corresponding to the direction of fabric transmission is provided with a fabric shoveling mechanism 15, and an edge sealing mechanism 16 is provided above one end of the fabric shoveling mechanism 15 away from the vertical cutting tool mechanism 9; the fabric shoveling mechanism 15 comprises shrapnel 1501 that are in contact with an upper surface of the material transferring belt 2, wherein one end of the shrapnel 1501 close to the vertical cutting tool mechanism 9 is tilted downwards, and an other end is provided with a pressure plate 1502; the shrapnel 1501 are connected to a side wall of the vertical cutting tool mechanism 9 via a shrapnel bracket 1503; the edge sealing mechanism 16 is provided above the pressure plate 1502, and a top part of the edge sealing mechanism 16 is connected to the side wall of the vertical cutting tool mechanism 9 via an edge sealing bracket 1601; the edge sealing mechanism 16 is a hot-air edge sealing mechanism or a heated-plate edge sealing mechanism or a light-curing adhesive edge sealing mechanism.

The vertical cutting tool mechanism 9 includes a rear plate 901 mounted with the shrapnel bracket 1503 and the edge sealing bracket 1601, an adjusting mechanism mounting plate 902 is provided at a relatively spaced distance from one end of the rear plate 901 away from the edge sealing mechanism 16, and the telescopic adjusting mechanism 20 is provided at an outer side of the adjusting mechanism mounting plate 902; two sides of the adjusting mechanism mounting plate 902 and the rear plate 901 are connected via a fixed lateral plate 904 to form a tool installation chamber, and a vertical cutting tool component 17 is provided in the tool installation chamber; the vertical cutting tool component 17 includes a blade 1701 corresponding to a middle part of two shrapnel 1501, and the blade 1701 is fixed on a knife loading board 1702; the knife loading board 1702 is connected to the fixed lateral plate 904 via a fine-tuning cylinder 1703, and four corners of the fixed lateral plate 904 are provided with four cloth-transferring wheels 905; belts 903 are sleeved on outside of the cloth-transferring wheels 905, on an outside of the fixed lateral plate 904 is provided with a second drive motor 910 which is connected with one cloth-transferring wheel 905; upper and lower sides of the belt 903 are respectively provided with a belt support plate 907 and a belt guide plate 908 which are connected with the fixed lateral plate 904, and the belt support plate 907 and the belt guide plate 908 are provided with a blade outlet 909 corresponding to the blade 1701; the cloth-transferring wheels 905 and the belts 903 are provided in two groups, and are respectively provided on two sides of the blade 1701; furthermore, a lowest edge of the shrapnel 1501 is in the same plane as a bottom of the belt 903.

In specific implementation, the lowest edge of the shrapnel is in the same plane as a bottom of the belt, when the cutting tool is in use, it's pressed on a surface of the fabric to be transferred, so that the lowest edge of the shrapnel is pressed on a surface of the material transferring belt; when the fabric is cut through the cutting tool, and is transported to the shrapnel from material transferring belt, the shrapnel will shovel up the fabric, while other parts of the fabric is still in contact with the surface of the material transferring belt, and only the part contacting with the shrapnel is shoveled, and then transferred to the edge sealing mechanism. The edge sealing mechanism can be selected according to characteristics of the fabric, such as glass fiber and cotton and linen fabrics will use light-curing edging mechanism, matched with light-curing adhesive and uv lamp for edging, if it is polyester fabric or other chemical fabrics, heated edge sealing device can be used, etc.; at the same time, the shrapnel will shovel the fabric far away from the material transferring belt, so that it does not touch the material transferring belt, to avoid that the heat sealing, light curing and other operations will damage the material transferring belt in the edge sealing process.

The horizontal cutting tool mechanism and vertical cutting tool mechanism of this embodiment are applicable to breathable felt or cut-resistant belt, which can solve the problem of fabric ultra-wide cutting, which cannot be implemented due to the large non-level error between the gantry and the platform;

When cutting horizontally, the electric sliding block moves on the electric slideway, and the tool moving support drives the tool mounting plate, the tool moving plate and the pressure wheel moving plate below to move together, which in turn makes the tool move on the fabric for cutting; at the same time, left and right sides of the tool moving plate are equipped with a cam plate, and the cam plate is able to play a role in lifting the tool, and when the cams are rotated from the lowest to the highest point, the cams lift the tool upwards, further lifts the tool; at the same time, there are two fine-tuning components, wherein the first fine-tuning component acts on the tool moving plate, which makes the tool have an up and down trajectory; the second fine-tuning component acts on the pressure wheel moving plate, to adjust the pressure wheel up and down, and then adjust the depth of the tool; in addition, the buffer component can provide a downward pressure for the tool moving plate and the pressure wheel moving plate, which enables the pressure wheel and blade to closely fit the felt.

Before vertical cutting, the vertical cutting tool mechanism is driven by the vertical cutting tool fixing support to move on the vertical cutting moving mechanism to adjust the spacing between the vertical cutting tools, and then adjust width of vertical cutting to the set width; before vertical cutting, the telescopic adjusting mechanism drives the vertical cutting tool mechanism to move upward for a certain distance, so that it passes through smoothly, and when it is necessary to carry out the cutting, the telescopic adjusting mechanism drives the vertical cutting tool mechanism to move downward, which makes the transmission belt contact with the vertical cutting blade, and at the same time, the vertical cutting blade is stabbed in and needs to be moved forward urgently, and the transmission belt can flatten the cutting area in the process of moving, so as to ensure the accuracy of cutting;

At the same time, in the event of vibration, the buffer component on the horizontal cutting tool mechanism plays a buffer role, the reset adjusting plate drives the vertical cutting knife loading support to move up to a certain distance via a connecting block; after the vibration, self reset telescopic mechanism promotes the vertical cutting knife loading support to move downwards, so that the vertical cutting blade is reset, to avoid deterioration of the blade caused by vibration.

In addition, when the size of the platform and the gantry is large, the aluminum of the gantry will collapse when it is wider, and it is impossible to ensure the parallelism between the gantry and the platform. The embodiment is able to solve the above problem through the setting of the horizontal cutting moving mechanism and the vertical cutting moving mechanism.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A full-automatic fabric rectangular cutting equipment, comprising a working frame and a material transferring belt set on an upper part of the working frame, a conveyor gantry support frame, a horizontal cutting moving mechanism and a vertical cutting moving mechanism set on the upper part of the working frame along running direction of the material transferring belt; a plurality of pressure sheets are set at intervals at a lower part of the conveyor gantry support frame, and one end of pressure sheets corresponding to running direction of the material transferring belt is connected with the horizontal cutting moving mechanism via pressure exerting components; on horizontal cutting moving mechanism is provided with a horizontal cutting tool mechanism, and on the vertical cutting moving mechanism is provided with vertical cutting tool mechanisms; in front of the working frame is provided with a plurality of cabinet doors with locks, in the cabinet door with lock is provided with a distribution box, bottom corners of the working frame is are provided with support feet.

2. The full-automatic fabric rectangular cutting equipment of claim 1, wherein each pressure exerting component includes a pressure-exerting head placed on an upper part of the pressure sheet in a contacting manner, a pressure-exerting apparatus is provided on an upper part of the pressure-exerting head, and an upper part of the pressure-exerting apparatus is connected to a bottom of the horizontal cutting moving mechanism via a connecting plate; the pressure-exerting apparatus is a pneumatic cylinder or a pressure spring.

3. The full-automatic fabric rectangular cutting equipment of claim 1, wherein the pressure sheet is a steel sheet with elasticity, and one side of the pressure sheet facing the material transferring belt is covered with a lubricating material layer; the pressure sheet includes a mounting portion connected to a bottom of the conveyor gantry support frame, a flat pressing portion corresponding to an upper surface of the material transferring belt, and an arc-shaped connecting portion connected with the flat pressing portion and the mounting portion.

4. The full-automatic fabric rectangular cutting equipment of claim 1, wherein the horizontal cutting moving mechanism includes a horizontal cutting gantry provided between the conveyor gantry support frame, on a top of the horizontal cutting gantry is provided with a top linear moving frame, and on a bottom thereof is provided with a cloth-pressing plate; a horizontal cutting lateral slideway is provided at one side of the horizontal cutting gantry, and the horizontal cutting tool mechanism is slidably connected to the top linear moving frame and the horizontal cutting lateral slideway via the horizontal cutting tool fixing support; the vertical cutting moving mechanism includes a vertical cutting gantry, and a top of the vertical cutting gantry is provided with a rack moving frame; one side of the vertical cutting gantry is provided with a vertical cutting lateral slideway, and the vertical cutting tool mechanism is connected to the rack moving support and vertical cutting lateral slideway by means of a vertical cutting tool fixing support.

5. The full-automatic fabric rectangular cutting equipment of claim 4, wherein the horizontal cutting tool fixing support includes a transverse plate set on a top of an electric sliding block in the linear moving support, and a vertical plate connected to the transverse plate towards the direction of the fabric; a bottom of the vertical plate is provided with a tool mounting plate, a tool moving plate, and a pressure wheel moving plate; one side of the horizontal cutting gantry near the vertical plate is also provided with a horizontal cutting lateral slideway, in the vertical plate is provided with a guiding sliding block in sliding connection with the horizontal cutting lateral slideway; a bottom of the tool moving plate is provided with a cutting knife, and the bottom of the tool moving plate is provided with a tool mounting slot, and the cutting knife is set inside the tool mounting slot; a bottom of the pressure wheel moving plate is rotatably connected to a pressure wheel; on both sides of the tool moving plate are outwardly provided with a cam plate, and the cam plate is connected to cams traveling on an upper part of the cloth-pressing plate.

6. The full-automatic fabric rectangular cutting equipment of claim 5, wherein the tool mounting plate is fixed to the bottom of the vertical plate, specifically, one side of the tool mounting plate near the tool moving plate is vertically provided with a first sliding bar, and two sides of the tool moving plate are respectively provided with a first sliding block corresponding to the tool mounting plate and a second sliding block corresponding to the pressure wheel moving plate; on the first sliding block is provided with a first sliding chute snapped fitted with the first sliding bar, one side of the second sliding block near the pressure wheel moving plate is vertically provided with a second sliding bar; one side of the pressure wheel moving plate near the second sliding block is provided with a third sliding block, and on the third sliding block is provided with a second sliding chute corresponding to the second sliding bar; at the same time, an outer side of the tool mounting plate is provided with a first limiting stopper connected to the first sliding block, an outer side of the second sliding block is provided with a second limiting stopper connected to the third sliding block, wherein the first limiting stopper and second limiting stopper are of the same structure, one end of the first limiting stopper is secured to an outer side of the tool mounting plate, and another end is vertically provided with a long hole; a limit column that is penetrated out of the long hole is provided on the second sliding block.

7. The full-automatic fabric rectangular cutting equipment of claim 6, wherein the tool moving plate is slid up and down on the tool mounting plate via a first fine-tuning component, and the pressure wheel moving plate is slid up and down on the tool moving plate via a second fine-tuning component; the first fine-tuning component comprises a first cylinder, a first fixing block and a first moving block connected to top and bottom ends of the first cylinder; the first fixing block is fixed to an outer side of the tool mounting plate, and the first moving block is fixed to an outer side of the first sliding block; the second fine-tuning component includes a second cylinder, a second fixing block, and a second moving block connected to upper and lower ends of the second cylinder, the second fixing block is fixed to an outer side of the second sliding block, and the second moving block is fixed to an outer side of the third sliding block; at the same time, a top of the tool moving plate is provided with a buffer component connected to the vertical plate, and the buffer component is a nitrogen gas spring.

8. The full-automatic fabric rectangular cutting equipment of claim 4, wherein the vertical cutting tool fixing support includes a transmission gear that engages with a rack moving frame, a transverse connecting plate that is set on the transmission gear, a lateral moving block that cooperates with the vertical cutting lateral slideway, and a vertical connecting plate that is connected with the transverse connecting plate and the lateral moving block; a bottom of the vertical connecting plate is connected to the vertical cutting tool mechanism via the telescopic adjusting mechanism, and on the transverse connecting plate is provided with a first drive motor that drives the transmission gear to rotate.

9. The full-automatic fabric rectangular cutting equipment of claim 8, wherein one end of the vertical cutting tool mechanism corresponding to the direction of fabric transmission is provided with a fabric shoveling mechanism, and an edge sealing mechanism is provided above one end of the fabric shoveling mechanism away from the vertical cutting tool mechanism; the fabric shoveling mechanism comprises shrapnel that are in contact with an upper surface of the material transferring belt, wherein one end of the shrapnel close to the vertical cutting tool mechanism is tilted downwards, and another end is provided with a pressure plate; the shrapnel are connected to a side wall of the vertical cutting tool mechanism via a shrapnel bracket; the edge sealing mechanism is provided above the pressure plate, and a top part of the edge sealing mechanism is connected to the side wall of the vertical cutting tool mechanism via an edge sealing bracket; the edge sealing mechanism is a hot-air edge sealing mechanism or a heated-plate edge sealing mechanism or a light-curing adhesive edge sealing mechanism.

10. The full-automatic fabric rectangular cutting equipment of claim 9, wherein the vertical cutting tool mechanism includes a rear plate mounted with the shrapnel bracket and the edge sealing bracket, an adjusting mechanism mounting plate is provided at a relatively spaced distance from one end of the rear plate away from the edge sealing mechanism, and the telescopic adjusting mechanism is provided at an outer side of the adjusting mechanism mounting plate; two sides of the adjusting mechanism mounting plate and the rear plate are connected via a fixed lateral plate to form a tool installation chamber, and a vertical cutting tool component is provided in the tool installation chamber; the vertical cutting tool component includes a blade corresponding to a middle part of two shrapnel, and the blade is fixed on a knife loading board; the knife loading board is connected to the fixed lateral plate via a fine-tuning cylinder, and four corners of the fixed lateral plate are provided with four cloth-transferring wheels; belts are sleeved on outside of the cloth-transferring wheels, on an outside of the fixed lateral plate is provided with a second drive motor which is connected with one cloth-transferring wheel; upper and lower sides of the belt are respectively provided with a belt support plate and a belt guide plate which are connected with the fixed lateral plate, and the belt support plate and the belt guide plate are provided with a blade outlet corresponding to the blade; the cloth-transferring wheels and the belts are provided in two groups, and are respectively provided on two sides of the blade; furthermore, a lowest edge of the shrapnel is in the same plane as a bottom of the belt.
